(19) United States
(12) Patent Application Publication
(10) Pub. No.: US 2009/0232248 A1
(43) Pub. Date: Sep. 17, 2009

(54) DATA RECEIVING DEVICE AND SEMICONDUCTOR INTEGRATED CIRCUIT INCLUDING SUCH DATA RECEIVING DEVICE

(75) Inventors: Muneo Fukaishi, Tokyo (JP); Kouichi Yamaguchi, Tokyo (JP); Kazuhisa Sunaga, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/294,217

(22) PCT Filed: Jan. 22, 2007
(86) PCT No.: PCT/JP2007/050900

§ 371 Date: Sep. 23, 2008

(30) Foreign Application Priority Data
Mar. 24, 2006 (JP) 2006-083576

(51) Int. Cl. H04L 25/49

(52) U.S. Cl. 375/291

(57) ABSTRACT

A data receiving device comprises amplifying circuit 41 that amplifies received duobinary data with a given gain into an output signal, offset canceler 56, 57 that cancel an offset of the output signal from amplifying circuit 41, data determiner 43, 44 that sample the output signal from amplifying circuit 41 based on a first reference voltage and a second reference voltage which is of a lower level than the first reference voltage to determine which one of three levels of the duobinary data the received duobinary data have.

### TECHNICAL FIELD

The present invention relates to a data receiving device and a semiconductor integrated circuit including such a data receiving device, e.g., a data receiving device which is incorporated in a transmission apparatus for sending and receiving an electric signal via a cable or an electric interconnect on a board, and which is suitable for receiving data sent by duobinary transmission, and a semiconductor integrated circuit including such a data receiving device.

### BACKGROUND ART

As semiconductor integrated circuits have been scaled down, their functionality has in recent years been enhanced by an increase in the operating speed of semiconductor chips and an increase in the integration thereof. The higher performance of the semiconductor chips has led to an increase in the amount of data that are exchanged between a plurality of chips. The amount of data is increased by increasing the number of signals or increasing the rate of signals. If the number of signals is increased in order to increase the amount of data, then the area of pads for extracting signals from integrated circuits is increased and the number of transmission paths such as electric interconnects on boards and cables is increased. Therefore, it is more efficient to increase the amount of data by increasing the transmission rate of signals.

However, it is practically difficult to increase the transmission rate of signals because the increased signal transmission rate tends to bring about signal attenuation and intersymbol interference where an attenuated signal waveform affects adjacent bits, due to the skin effect and dielectric loss of the transmission path. For the purposes of preventing signal amplitude reductions owing to signal attenuations and signal timing degradations owing to an increase in the intersymbol interference, duobinary transmission has begun to be used in the art. According to the duobinary transmission scheme, adjacent bits are allowed to interfere with each other to reduce the amount of signal attenuation and also to reduce the signal timing degradation due to the intersymbol interference.

FIG. 1 is a diagram showing the waveform of received data according to the duobinary transmission scheme.

In the duobinary transmission scheme, present received data changes depending on data sent from the transmission source, particularly data that has been sent most recently. For example, when the most recently sent data is “0”, the received data is “0” if the presently sent data is “0”, and the received data is “1” if the presently sent data is “1”. When the most recently sent data is “1”, the received data is “1” if the presently sent data is “0”, and the received data is “2” if the presently sent data is “1”.

Therefore, in the duobinary transmission scheme, as shown in FIG. 1, the data received by the data receiving device is three-level data which may be “0” (low level), “1” (intermediate level), or “2” (high level). The data receiving device needs to determine these data having three levels. The three-level data “0”, “1”, “2” are determined in a first eye opening and a second eye opening. In the first eye opening, “0” and “1” are determined, and in the second eye opening, “1” and “2” are determined. In this case, a low reference voltage Vref− is used in the first eye opening and a high reference voltage Vref+ is used in the second eye opening for determining three-level signals of duobinary data.

FIG. 2 is a block diagram showing the electric arrangement of a data receiving device for receiving data sent according to the duobinary transmission scheme.

The data receiving device comprises multilevel-determining sampling latches 1, 2, offset canceling control circuits 3, 4, and decoder 5. Multilevel-determining sampling latches 1, 2 determine whether the level of duobinary data dat sent from a transmitter, not shown, is high or low with respect to reference voltages Vref+, Vref− in synchronism with clock signal CLK. Multilevel-determining sampling latch 1 determines the data of the second eye opening shown in FIG. 1 and outputs decision signal “a”, and multilevel-determining sampling latch 2 determines the data of the first eye opening and outputs decision signal “b”. Offset canceling control circuit 3 sends offset canceling control signals c1, c2 to multilevel-determining sampling latch 1. Offset canceling control circuit 4 sends offset canceling control signals d1, d2 to multilevel-determining sampling latch 2. Decoder 5 decodes decision signals “a”, “b” to recover the data that have been sent.

FIG. 3 is a circuit diagram showing the electric arrangement of multilevel-determining sampling latch 1 shown in FIG. 2.

As shown in FIG. 3, multilevel-determining sampling latch 1 comprises p-channel MOSFETs (hereinafter referred to as “pMOS”) 11, 12, 13, 14 15, 16, 17, n-channel MOSFETs (hereinafter referred to as “nMOS”) 18, 19, 20, 21, 22, 23, 24, and offset cancelers 25, 26. Multilevel-determining sampling latch 1 is supplied with differential input data DIN, DINB as duobinary data dat, determines the eye openings of the duobinary data based on the result of a comparison between reference voltages Vref+, Vref− and input data DIN, DINB at the time clock signal CLK is input, and determine the received data. Multilevel-determining sampling latch 2 is of the same structure, except that reference voltage Vref+ is applied to the gate of nMOS 22 and reference voltages Vref− to the gate of nMOS 23.

If the transmitted data becomes higher in rate, then the signal attenuation over the transmission path becomes greater, and the eye openings of duobinary data dat that is input to the data receiving device become smaller. In addition, as the transmission path becomes longer, the signal attenuation becomes greater, and as the signal rate becomes higher, the signal attenuation becomes greater even through the transmission distance remains constant. Accordingly, variations in the threshold voltages on two nMOSs 20, 21 used to input the data to multilevel-determining sampling latches 1, 2 make it difficult to accurately determine data having small eye openings and hence to tend to make more decision errors. Furthermore, MOS transistor variations become greater as components required for high-speed operation are scaled down. Consequently, for transmitting signals at high rates, it is necessary to solve the problems of signal attenuations due to higher signal rates, signal attenuations due to longer signal transmission distances, and threshold voltage variations owing to scaled-down components used for high-speed operation of the MOS transistors (nMOSs 20, 21).

In order to cancel offsets caused by threshold voltage variations of nMOSs 20, 21 that serve as a differential transistor pair, offset cancelers 25, 26 are used to control the drain currents of nMOSs 20, 21. Specifically, offset canceler 25 controls the drain current of nMOS 20 with offset canceling control signal c1 from offset canceling control circuit 3, and offset canceler 26 controls the drain current of nMOS 21 with offset canceling control signal c2, thereby canceling offsets caused by threshold voltage variations of nMOSs 20, 21. Multilevel-determining sampling latch 2 shown in FIG. 2 is of the same structure as multilevel-determining sampling latch 1. Offset canceler 25 in multilevel-determining sampling latch 2 controls the drain current of nMOS 20 with offset canceling control signal d1 from offset canceling control circuit 4. Offset canceler 26 in multilevel-determining sampling latch 2 controls the drain current of nMOS 21 with offset canceling control signal d2 from offset canceling control circuit 4, thereby canceling offsets caused by threshold voltage variations of nMOSs 20, 21 in multilevel-determining sampling latch 2.

FIG. 4 is a timing chart illustrative of the operation of the data receiving device shown in FIG. 2. In FIG. 4, the first eye opening is indicated by B1, B2, . . . , and the second eye opening by A1, A2, . . . . The data receiving device requires a clock signal having the same frequency as the transmission data rate. For example, if the transmission data rate is 10 Gb/s, then clock signal CLK having a frequency of 10 GHz is required. Multilevel-determining sampling latches 1, 2 determines the first and second eye openings at the timing of positive-going edges of clock signal CLK, and outputs decision signals “a”, “b”. Decision signals “a”, “b” are decoded by decoder 5 into the data that have been sent.

There is known a parallelization system for operating the data receiving device at a higher speed by obtaining a timing signal used for determining eye openings from a plurality of clock signals, rather than the single clock signal. FIG. 5 is a block diagram showing the electric arrangement of a parallelized data receiving device. Those parts of the parallelized data receiving device which are identical to those shown in FIG. 2 are denoted by identical reference characters. The data receiving device includes, in addition to the data receiving device shown in FIG. 2, multilevel-determining sampling latches 31, 32, offset canceling control circuits 33, 34, inverter 35, and flip-flops 36, 37, 38, 39, and employs decoder 5A instead of decoder 5 shown in FIG. 2.

FIG. 6 is a timing chart illustrative of the operation of the data receiving device shown in FIG. 5.

As shown in FIG. 6, the data receiving device uses two clock signals CLK, CLKB having a rate which is half the transmission rate. Clock signals CLK, CLKB have a phase of 0 degree and a phase of 180 degrees, respectively. Multilevel-determining sampling latches 1, 2 determine duobinary data dat at the timing of positive-going edges of clock signal CLK, and output decision signals “a”, “b”. Multilevel-determining sampling latches 31, 32 determine duobinary data dat at the timing of positive-going edges of clock signal CLKB, and output decision signals “e”, “f”. Decision signals “a”, “b”, “e”, “f” are delivered in synchronism with clock signal CLK by flip-flops 36, 37, 38, 39 to decoder 5A, which recovers the data that have been sent.

With the data receiving device being thus operated using a plurality of clock signals that are out of phase with each other, the operating speed of the clock signals and the multilevel-determining sampling latches is lowered, making it possible for the data receiving device to achieve high-speed operation. However, even though the operating speed of the data receiving device is lowered, since the rate of the received data that have been sent remains unchanged, the eye openings of the received data become smaller as the rate of the received data goes higher and the data are transmitted over long distances, so that operation errors caused by threshold voltage variations of multilevel-determining sampling latches 1, 2, 31, 32 cannot be prevented from occurring. Consequently, the offset canceling function (the offset canceling control circuits) is indispensable for dealing with threshold voltage variations of the MOS transistors.

The offset canceling function is required for each of the multilevel-determining sampling latches. If the number of multilevel-determining sampling latches increases depending on parallelized circuits in the data receiving device, then the number of offset canceling control circuits also increases in proportion to the increased number of multilevel-determining sampling latches. More parallelization with clock signals in four or eight phases result in a further reduction in the operating speed of the data receiving device, which is allowed to perform higher-speed operation. However, the parallelization increases the number of multilevel-determining sampling latches, i.e., the number of differential transistor pairs for being supplied with the received data, and also increases the number of offset canceling control circuits which compensate for characteristic variations of those transistors.

Besides the above data receiving device, other technologies of the type described above according to the background art are disclosed in the documents shown below.

An A/D converter disclosed in Patent document 1 includes an offset canceling circuit for detecting an offset independently of a voltage comparing circuit and generating a canceling signal depending on the offset. The voltage comparing circuit compares a signal voltage and a reference voltage with each other, and adds an inverted offset for canceling out the offset input to the voltage comparing circuit, to the offset based on the offset canceling signal. The reference voltage is generated by a voltage divider. A switch circuit supplies signal voltages to a reference voltage input terminal and a signal voltage input terminal of the voltage comparing circuit during an offset detecting period. The voltage comparing circuit outputs the result of the comparison depending on the offset input thereto. The offset canceling circuit generates the offset canceling signal based on the result of the comparison.

A differential amplifier disclosed in Patent document 2 includes a current source for supplying complementary currents to the drains of a differential pair to cancel an offset.

A multilevel identifying circuit disclosed in Patent document 3 includes a DC amplifier with an offset adjusting function which amplifies a multilevel signal input thereto. An output signal from the DC amplifier is identified by an A/D converter, which outputs a signal having at least (N+2) bits.

Patent document 4 discloses a duobinary AM•PSK demodulating circuit comprising two comparators for determining three levels of a baseband signal and a single comparator for determining two levels. Based on the fact that the baseband has three levels when it has a certain pattern, such a pattern is detected by a match detecting circuit, and in most cases other than such a pattern, the duobinary AM•PSK demodulating circuit switches to an output signal from the comparator for determining two levels. In this manner, sampling clock jitter, waveform distortions, and a noise-induced decision error rate are reduced.

Patent document 1: JP-A 2000-165241

Patent document 2: JP-A 09-130172

Patent document 3: JP-B 06-011122

Patent document 4: JP-B 06-091560

### DISCLOSURE OF THE INVENTION

### Problems to be Solved by the Invention

However, the above data receiving devices of the background art have suffered the following problems:

Though the duobinary transmission scheme makes it possible to reduce signal attenuation responsible for causing obstacles to higher-speed operation and timing degradation due to intersymbol interference, the eye openings are reduced by higher-speed operation and longer transmission distances. In order to accurately receive the reduced eye openings, the data receiving device shown in FIG. 2 requires a mechanism for canceling an offset due to variations in the threshold voltage between the differential pair transistors on the input side. Since it is necessary to distinguish between the first eye opening and the second eye opening according to the duobinary transmission scheme, the data receiving device needs two multilevel-determining sampling latches, and hence two offset canceling mechanisms and two control circuits for controlling the offset canceling mechanisms. If a plurality of identical data receiving devices are parallelized and the clock signal and the sampling latches are lowered at operation rate for higher-speed operation, then the parallelized data receiving devices need as many offset canceling mechanisms and as many offset canceling control circuits for controlling the offset canceling mechanisms. Therefore, the circuit scale is increased, and so is the power consumption.

The A/D converter disclosed in Patent document 1 is not supplied with duobinary data as input data, and hence is different from the present invention as to structure and object and does not improve the above problems.

The differential amplifier disclosed in Patent document 2 is similar in hardware to the differential amplifier used in the present invention as complementary currents are supplied to the drains of a differential pair. However, since no duobinary data are input to the differential amplifier, the differential amplifier is different from the present invention as to structure and object and does not improve the above problems.

The multilevel identifying circuit disclosed in Patent document 3 is similar in hardware to the differential amplifier used in the present invention as it has a DC amplifier with an offset adjusting function. However, since no duobinary data are input to the multilevel identifying circuit, the multilevel identifying circuit is different from the present invention as to structure and object and does not improve the above problems.

The duobinary AM•PSK demodulating circuit disclosed in Patent document 4 is used to reduce sampling clock jitter, waveform distortions, and a noise-induced decision error rate. Therefore, the duobinary AM•PSK demodulating circuit is different from the present invention as to structure and object and does not improve the above problems.

The present invention has been made in view of the above problems. It is an object of the present invention to provide a data receiving device which has a reduced circuit scale and a reduced power consumption rate, and a semiconductor integrated circuit including such a data receiving device.

### Means for Solving the Problems

To accomplish the above object, according to an invention defined by claim 1, a data receiving device for receiving duobinary data includes an amplifying circuit for amplifying received duobinary data with a given gain into an output signal, an offset canceler for canceling an offset of the output signal from the amplifying circuit, and a data determiner for sampling the output signal from the amplifying circuit based on a first reference voltage and a second reference voltage which is of a lower level than the first reference voltage to determine which one of three levels of the duobinary data the received duobinary data have.

According to an invention defined by claim 2, in a data receiving device according to claim 1, the duobinary data includes differential data, the amplifying circuit includes a differential amplifier including two transistors for being supplied with the differential data, amplifying the differential data, and differentially outputting the output signal, and the offset canceler controls currents flowing through output sections of the transistors to cancel an offset of the output signal.

According to an invention defined by claim 3, in a data receiving device according to claim 2, the data determiner includes a first multilevel-determining circuit for sampling the output signal from the amplifying circuit based on the first reference voltage and the second reference voltage to determine whether the received duobinary data are of a high level or an intermediate level among the three levels of the duobinary data, a first sampling latch for latching a first decision signal from the first multilevel-determining circuit, a second multilevel-determining circuit for sampling the output signal from the amplifying circuit based on the first reference voltage and the second reference voltage to determine whether the received duobinary data are of a low level or the intermediate level among the three levels of the duobinary data, and a second sampling latch for latching a second decision signal from the second multilevel-determining circuit.

According to an invention defined by claim 4, a data receiving device for receiving duobinary data includes a data determiner for sampling the duobinary data based on a first reference voltage and a second reference voltage which is of a lower level than the first reference voltage to determine which one of three levels of the duobinary data the received duobinary data have, wherein the data determiner includes a first multilevel-determining circuit for sampling the duobinary data based on the first reference voltage to determine whether the received duobinary data are of a high level or an intermediate level among the three levels of the duobinary data, a first sampling latch for latching a first decision signal from the first multilevel-determining circuit, a second multilevel-determining circuit for sampling the duobinary data based on the second reference voltage to determine whether the received duobinary data are of a low level or the intermediate level among the three levels of the duobinary data, and a second sampling latch for latching a second decision signal from the second multilevel-determining circuit.

According to an invention defined by claim 5, in a data receiving device according to claim 4, the first multilevel-determining circuit includes a first offset canceler for canceling an offset of the first decision signal of the first multilevel-determining circuit, and the second multilevel-determining circuit includes a second offset canceler for canceling an offset of the second decision signal of the second multilevel-determining circuit.

According to an invention defined by claim 6, in a data receiving device according to claim 4 or 5, the duobinary data includes differential data, each of the first multilevel-determining circuit and the second multilevel-determining circuit includes a differential amplifier having two transistors for being supplied with the differential data, amplifying the differential data, and differentially outputting an output signal, and each of the first offset canceler and the second offset canceler controls currents flowing through output sections of the transistors to cancel an offset of the first decision signal and the second decision signal.

According to an invention defined by claim 7, in a data receiving device according to claim 6, the data determiner includes a first multilevel-determining circuit for sampling the duobinary data based on the first reference voltage and the second reference voltage to determine whether the received duobinary data are of a high level or an intermediate level among the three levels of the duobinary data, a first sampling latch for latching a first decision signal from the first multilevel-determining circuit, a second multilevel-determining circuit for sampling the duobinary data based on the first reference voltage and the second reference voltage to determine whether the received duobinary data are of a low level or the intermediate level among the three levels of the duobinary data, and a second sampling latch for latching a second decision signal from the second multilevel-determining circuit.

According to an invention defined by claim 8, in a data receiving device according to claim 4, 5, 6, or 7, the first sampling clutch includes a plurality of latch circuits for latching the first decision signal in synchronism with a plurality of clock signals which are out of phase with each other, and the second sampling clutch includes a plurality of latch circuits for latching the first decision signal in synchronism with the plurality of clock signals.

According to an invention defined by claim 9, a semiconductor integrated circuit includes a data receiving device according to any one of claims 1 through 8.

### ADVANTAGES OF THE INVENTION

With the arrangement of the present invention, since the duobinary data are determined by sampling an output signal representative of the duobinary data amplified by the amplifier, with the data determiner, decision errors caused by the data determiner are reduced. If the amplifying circuit is capable of canceling an offset of the output signal thereof, then decision errors caused by the data determiner are further reduced. Since only one arrangement is required to cancel an offset of the output signal from the amplifier, when the data receiving device is incorporated in a semiconductor integrated circuit, the area taken up by an offset canceling mechanism and a control circuit in the semiconductor integrated circuit may be small, resulting in a reduction in power consumption.

The data determiner includes the first multilevel-determining circuit, the first sampling latch, the second multilevel-determining circuit, and the second sampling latch. Therefore, the operating speed of the first and second multilevel-determining circuit is increased. The data determiner includes the first multilevel-determining circuit for sampling the duobinary data using the first reference voltage (or the first and second reference voltages) to determine whether the received duobinary data are of the high level or the intermediate level, the first sampling latch for latching the first decision signal from the first multilevel-determining circuit, the second multilevel-determining circuit for sampling the duobinary data using the second reference voltage (or the first and second reference voltages) to determine whether the received duobinary data are of the low level or the intermediate level, and the second sampling latch for latching the second decision signal from the second multilevel-determining circuit. Although two arrangements for canceling an offset are required, the power consumption is reduced because there is no amplifying circuit. As the amplifying circuit includes the differential amplifier for amplifying the differential duobinary data and differentially outputting the output signal, the signals in the various portions suffer reduced noise and distortions, further reducing decision errors caused by the data determiner. Since the first and second multilevel-determining circuits include a differential amplifier for amplifying the differential duobinary data and differentially outputting the output signal, decision errors of the data determiner are further reduced.

### BRIEF DESCRIPTION OF THE DRAWINGS

FIG. 1 is a diagram showing the waveform of received data according to the duobinary transmission scheme;

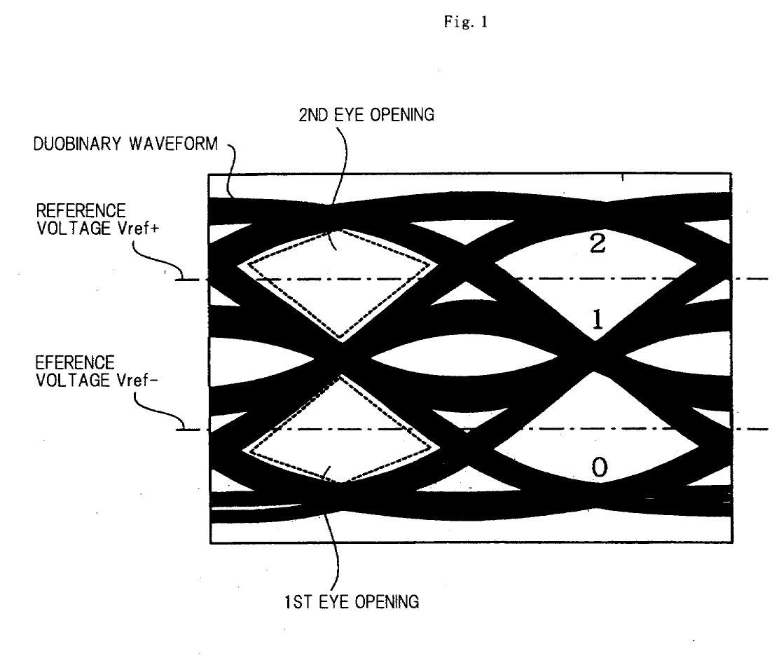

FIG. 2 is a block diagram showing the electric arrangement of a data receiving device for receiving data sent according to the duobinary transmission scheme;

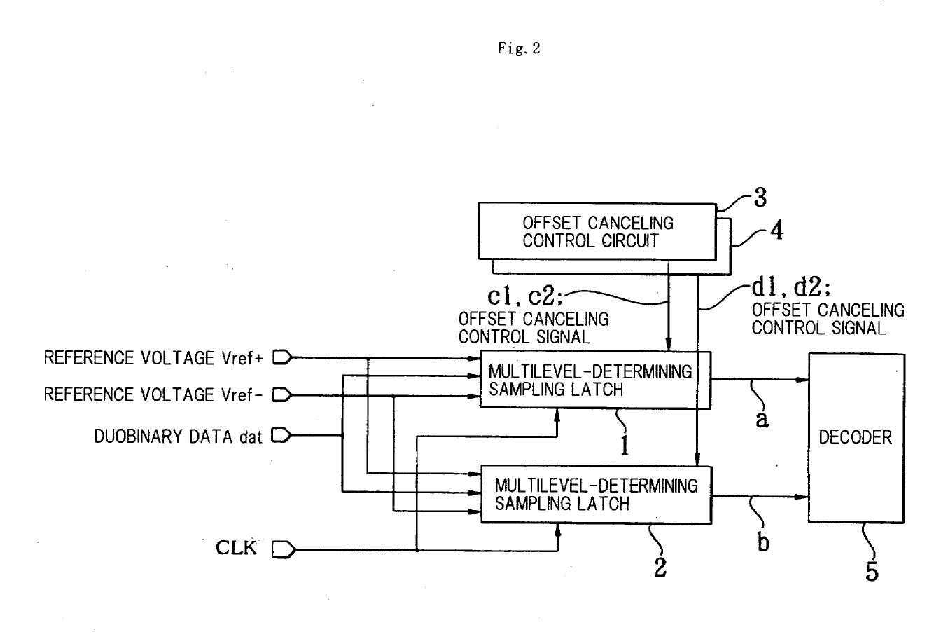

FIG. 3 is a circuit diagram showing the electric arrangement of multilevel-determining sampling latch 1 shown in FIG. 2;

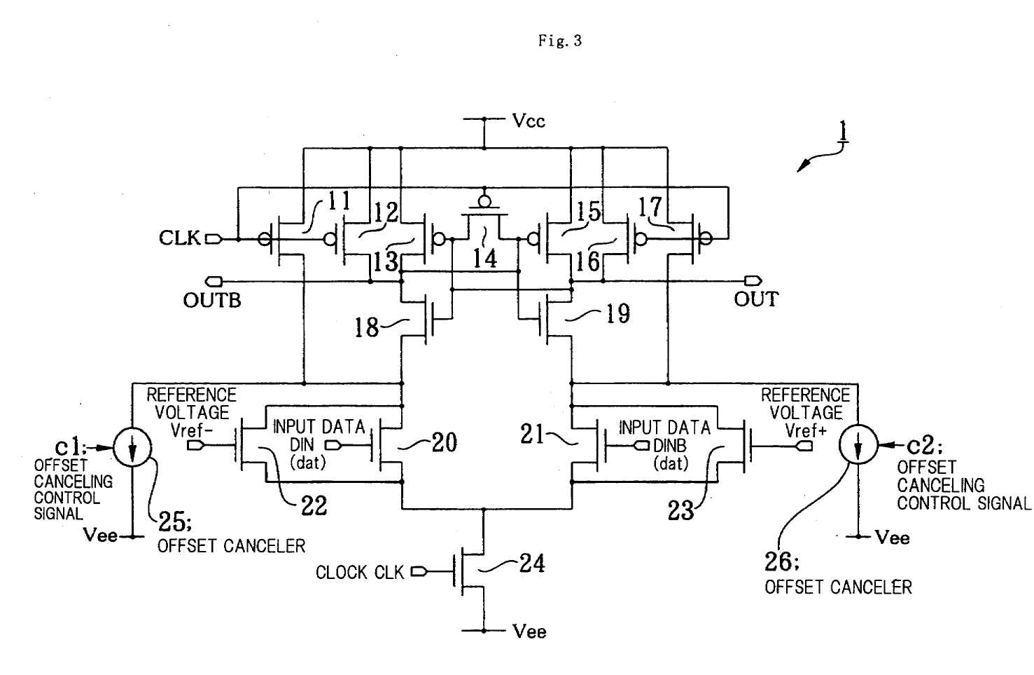

FIG. 4 is a timing chart illustrative of the operation of the data receiving device shown in FIG. 2;

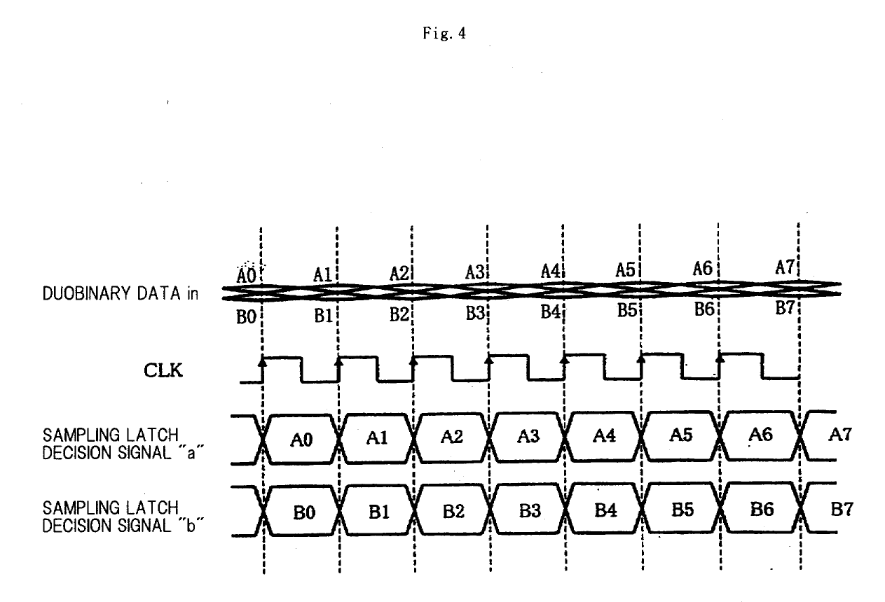

FIG. 5 is a block diagram showing the electric arrangement of a parallelized data receiving device;

FIG. 6 is a timing chart illustrative of the operation of the data receiving device shown in FIG. 5;

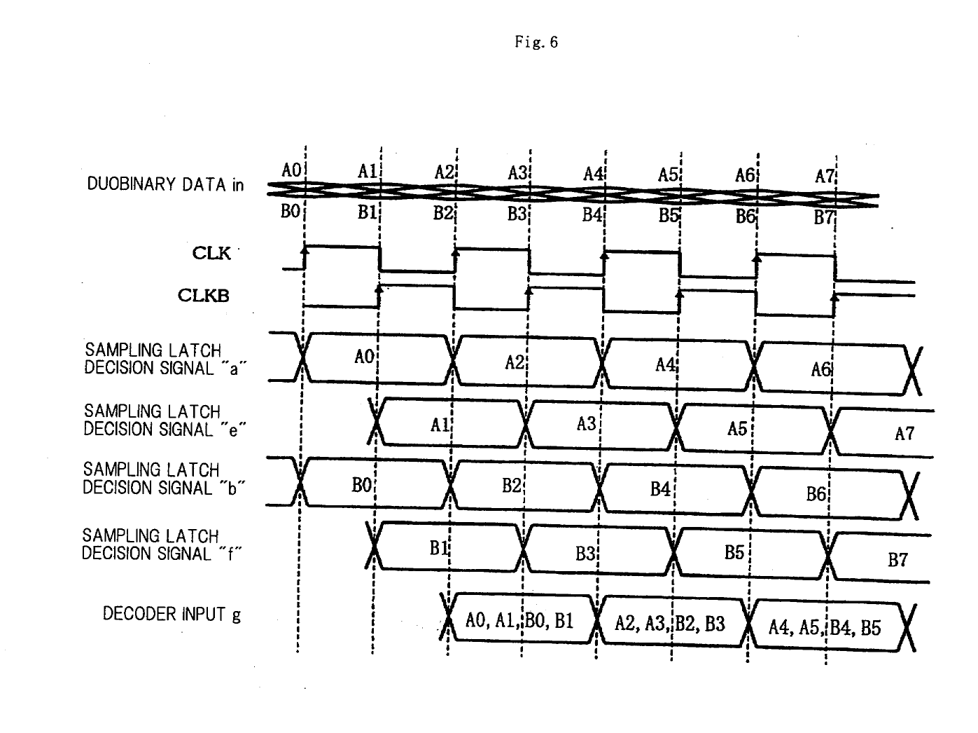

FIG. 7 is a block diagram showing the electric arrangement of a central portion of a data receiving device according to a first exemplary embodiment of the present invention;

FIG. 8 is a circuit diagram showing the electric arrangement of amplifier 41 shown in FIG. 7;

FIG. 9 is a circuit diagram showing the electric arrangement of multilevel-determining sampling latch 43 shown in FIG. 7;

FIG. 10 is a timing chart of signals in various portions illustrative of the operation of the data receiving device shown in FIG. 7;

FIG. 11 is a block diagram showing the electric arrangement of a central portion of a data receiving device according to a second exemplary embodiment of the present invention;

FIG. 12 is a circuit diagram showing the electric arrangement of multilevel-determining circuit 81 shown in FIG. 11;

FIG. 13 is a circuit diagram showing the electric arrangement of sampling latch 82 shown in FIG. 11;

FIG. 14 is a block diagram showing the electric arrangement of a central portion of a data receiving device according to a third exemplary embodiment of the present invention;

FIG. 15 is a circuit diagram showing the electric arrangement of offset-canceling multilevel-determining circuit 81A shown in FIG. 14;

FIG. 16 is a block diagram showing the electric arrangement of a data receiving device which includes parallelized data receiving devices shown in FIG. 14; and

FIG. 17 is a timing chart illustrative of the operation of the data receiving device shown in FIG. 16.

### DESCRIPTION OF REFERENCE CHARACTERS

41 amplifier (amplifying circuit)
42, 85 offset canceling control circuit (part of a data receiving device)
43, 44 multilevel-determining sampling latch (data determiner)
45, 45A decoder (part of a data receiving device)
51, 52 nMOS (part of the amplifying circuit)
53, 54 resistor (part of the amplifying circuit)
55 nMOS (part of the amplifying circuit)
56, 57, 98, 99 offset canceler (part of the amplifying circuit)
81, 83 multilevel determining circuit (data determiner)
81A, 83A offset-canceling multilevel determining circuit (data determiner)
82, 84, 101, 102 sampling latch (latch circuit)

### BEST MODE FOR CARRYING OUT THE INVENTION

An exemplary embodiment of the present invention is concerned with a data receiving device including an offset-canceling multilevel determining circuit for determining the value of duobinary data by sampling an output signal representative of duobinary data amplified by an amplifier, with a multilevel-determining sampling latch, and determining multilevel data and canceling an offset with the same circuit, and a semiconductor integrated circuit incorporating such a data receiving device.

### Exemplary Embodiment 1

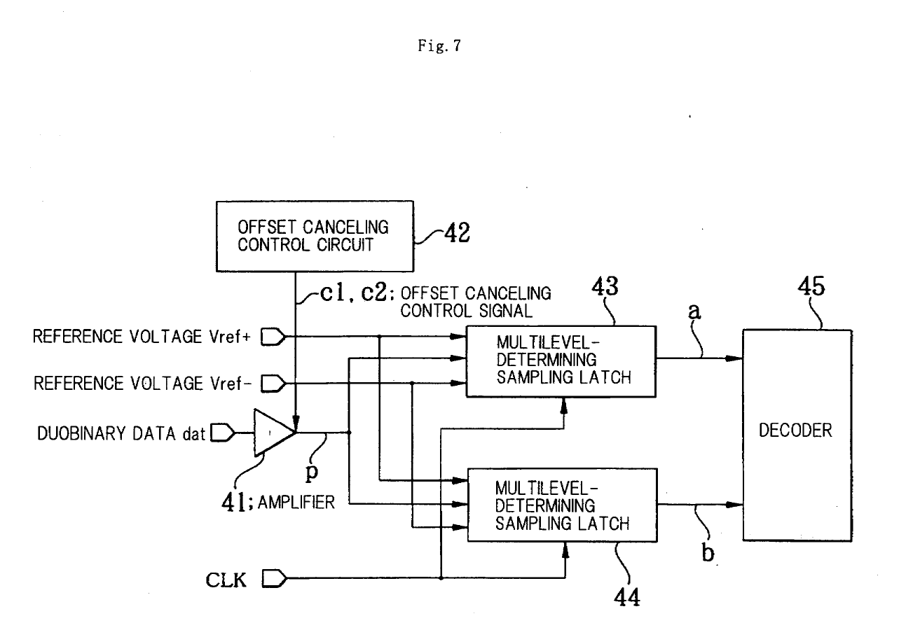

FIG. 7 is a block diagram showing the electric arrangement of a central portion of a data receiving device according to a first exemplary embodiment of the present invention.

As shown in FIG. 7, the data receiving device includes amplifier 41, offset canceling control circuit 42, multilevel-determining sampling latches 43, 44, and decoder 45. Amplifier 41 receives duobinary data dat sent from a transmitter, not shown, and amplifies duobinary data dat with a given gain into an output signal “p”. Duobinary data dat comprise three-level data having a high level (“2”), a low level (“0”), and an intermediate level (“1”).

Amplifier 41 is also capable of canceling an offset of output signal “p”. According to the present exemplary embodiment, in particular, duobinary data dat comprise differential data, and amplifier 41 includes a differential amplifier having two transistors for being supplied with the differential data and amplifying the differential data and differentially outputting output signal “p”. Based on offset canceling control signals c1, c2 from offset canceling control circuit 42, amplifier 41 controls currents flowing in the output sections of the transistors to cancel the offset of output signal “p”. Since the data received by amplifier 41 are duobinary data, amplifier 41 may have an operating frequency band which is ⅔ of the transmission data rate. For example, if the transmission data rate is 10 Gbps, then for amplifying normal binary data, amplifier 41 needs a frequency band of 5 GHz equal to the symbol rate of the 10 Gbps data, but for amplifying duobinary data, amplifier 41 may have a frequency band of about 3.3 GHz which is ⅔ of 5 GHz. If sampling latches having a high operating speed are preceded by an amplifier having an operating speed lower than the operating speed of the sampling latches, the amplifier is responsible for causing obstacles to higher-speed operation of the data receiving device. According to the duobinary transmission scheme, however, amplifier 41 does not cause a reduction in the operating speed.

Multilevel-determining sampling latch 43 samples output signal “p” from amplifier 41 based on reference voltage Vref+ having a relatively high level for determining the intermediate level and the high level, to determine the data of output signal “p”, and differentially outputs decision signal “a”. Multilevel-determining sampling latch 44 samples output signal “p” from amplifier 41 based on reference voltage Vref− having a relatively low level for determining the intermediate level and the low level, to determine the data of output signal “p”, and differentially outputs decision signal “b”. Vref− is lower in voltage level than Vref+. Decoder 45 decodes decision signals “a”, “b” to recover the data that have been sent. The data receiving device is incorporated in a semiconductor integrated circuit.

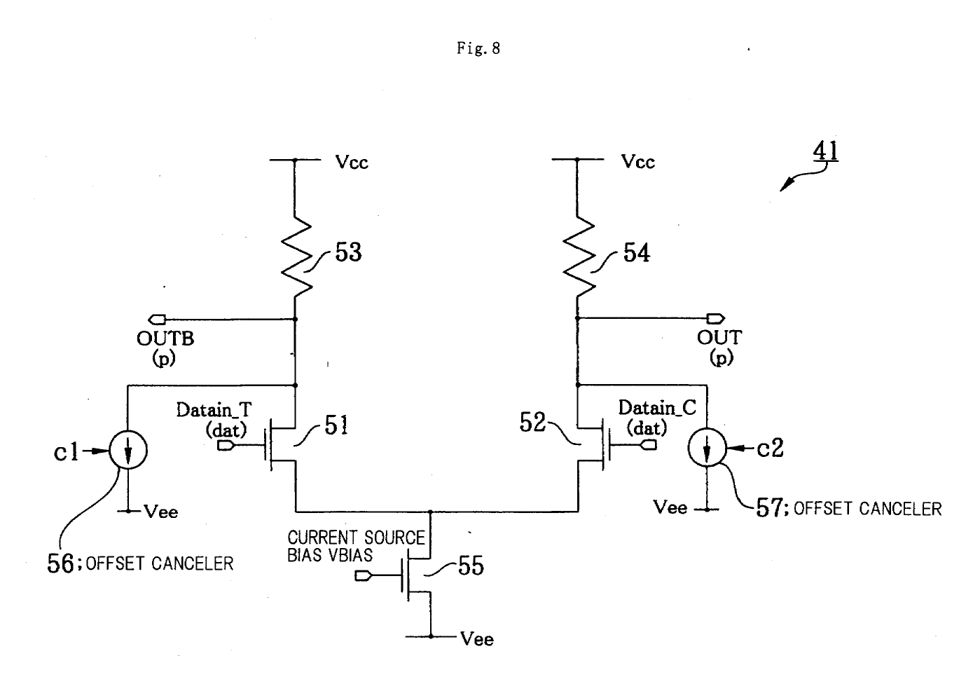

FIG. 8 is a circuit diagram showing the electric arrangement of amplifier 41 shown in FIG. 7.

As shown in FIG. 8, amplifier 41 includes nMOSs 51, 52, resistors 53, 54, nMOS 55, and offset cancelers 56, 57. nMOSs 51, 52 are supplied with differential duobinary data dat. nMOS 55 operates as a constant-current circuit with a current source bias being applied to a gate electrode thereof. Offset cancelers 56, 57 include variable resistors such as MOS transistor cathode followers, and control currents based on offset canceling control signals c1, c2 from offset canceling control circuit 42.

In amplifier 41, the current flowing through offset canceler 56 is controlled based on offset canceling control signal c1 from offset canceling control circuit 42, and the current flowing through offset canceler 57 is controlled based on offset canceling control signal c2 from offset canceling control circuit 42. The current of offset canceler 56 is added to the drain current of nMOS 51 to control the current flowing in the output section of nMOS 51, and the current of offset canceler 57 is added to the drain current of nMOS 52 to control the current flowing in the output section of nMOS 52, thereby outputting from terminals OUT, OUTB differential output signal “p” from which an offset due to variations in the threshold voltages of nMOSs 51, 52 is canceled.

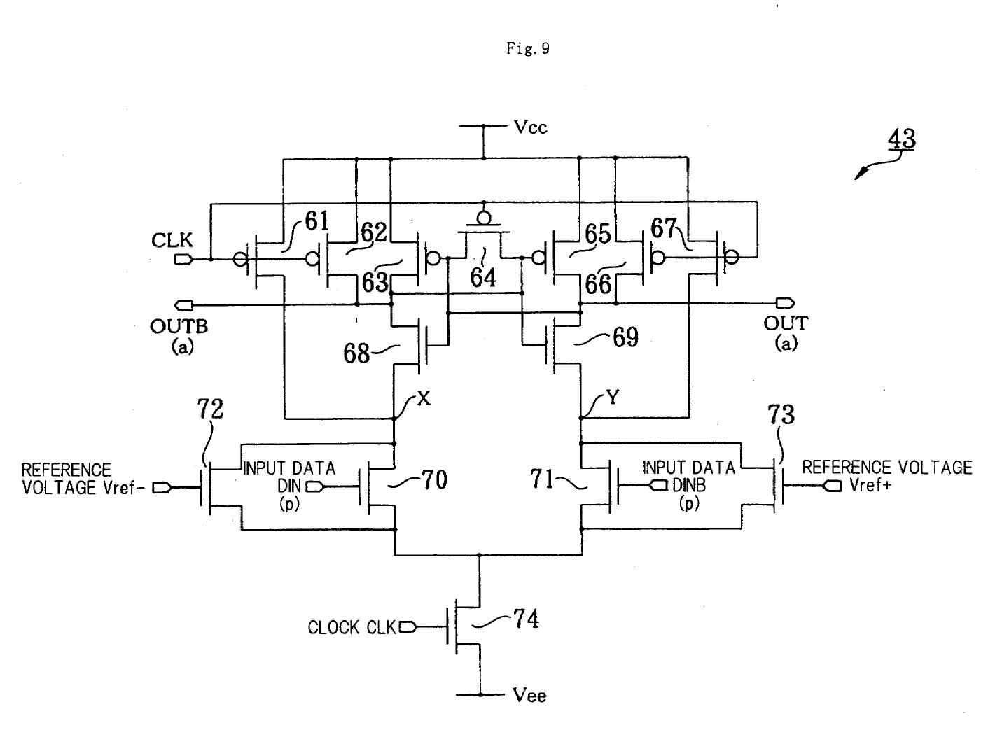

FIG. 9 is a circuit diagram showing the electric arrangement of multilevel-determining sampling latch 43 shown in FIG. 7.

As shown in FIG. 9, multilevel-determining sampling latch 43 includes pMOSs 61, 62, 63, 64, 65, 66, 67 and nMOSs 68, 69, 70, 71, 72, 73, 74. When clock signal CLK is input to multilevel-determining sampling latch 43, multilevel-determining sampling latch 43 determine small differences between the magnitudes of differential output signal “p” of amplifier 41 and reference voltages Vref+, Vref−. Specifically, when clock signal CLK is of a low level (“L” which is substantially the level of power supply potential Vee), nMOS 74 is turned off and pMOSs 61, 62, 66, 67 are turned on, precharging terminals OUT, OUTB and nodes X, Y to the level of power supply potential Vcc. In other words, when clock signal CLK is of a low level, V(X)=V(Y)=H and V(OUT)=V(OUTB)=H.

With the terminals and the nodes being thus precharged, when clock signal CLK goes to a high level (“H” which is substantially the level of power supply potential Vcc) while there is a difference between the data pair (differential output signal “p” and reference voltages Vref+, Vref−), a difference is developed as to the manner in which the potentials at nodes X, Y drop. The latch that is made up of pMOSs 63, 64, 65 and nMOSs 68, 69 increases the difference eventually to the state where V(OUT)=H and V(OUTB)=L or V(OUT)=L and V(OUTB)=H. Multilevel-determining sampling latch 44 is of the same structure as multilevel-determining sampling latch 43, except that reference voltage Vref+ is applied to the gate of nMOS 72 and reference voltages Vref− to the gate of nMOS 73.

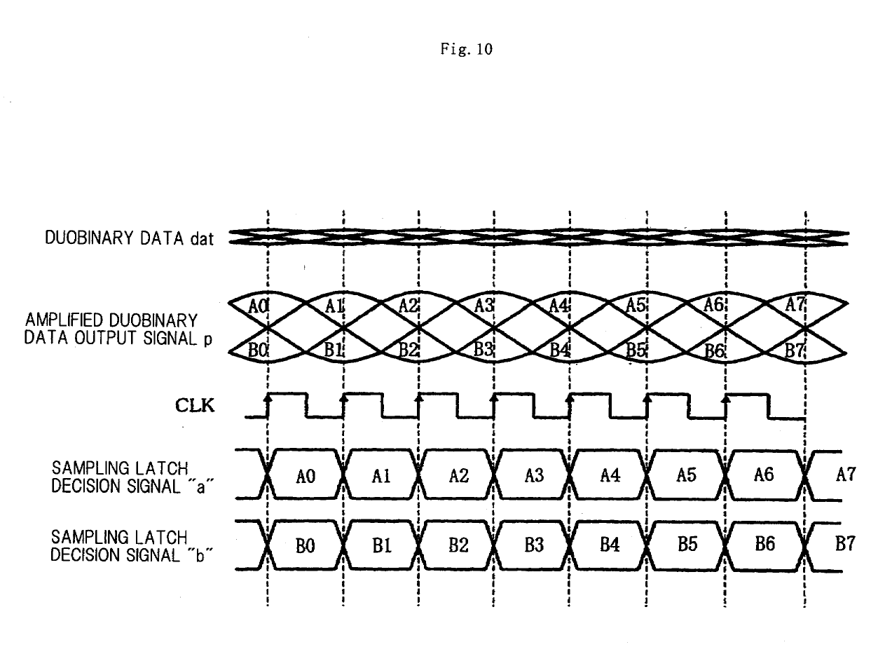

FIG. 10 is a timing chart of signals in various portions illustrative of the operation of the data receiving device shown in FIG. 7. The vertical axis represents the logic level and the horizontal axis the time.

Operation of the data receiving device according to the present exemplary embodiment will be described below with reference to FIG. 10.

In the data receiving device, duobinary data dat that has been set are amplified by amplifier 41, which outputs output signal “p”. As shown in FIG. 10, output signal “p” is shown as having first eye openings B1, B2, and second eye openings A1, A2, . . . amplified. Based on offset canceling control signals c1, c2 from offset canceling control circuit 42, an offset of output signal “p” from amplifier 41 is canceled. At the timing of positive-going edges of clock signal CLK, multilevel-determining sampling latches 43, 44 sample the first and second eye openings of output signal “p” from amplifier 41 based on reference voltages Vref+, Vref− to determine the value of output signal “p”, and output decision signals “a”, “b”. Decoder 45 decodes decision signals “a”, “b” to recover the data that have been sent.

According to the first exemplary embodiment, since the data of output signal “p” is determined by sampling output signal “p” representative of duobinary data dat amplified by amplifier 41, with multilevel-determining sampling latches 43, 44, decision errors are reduced even if multilevel-determining sampling latches 43, 44 have characteristic variations. As an offset of output signal “p” from amplifier 41 is canceled based on offset canceling control signals c1, c2 from offset canceling control circuit 42, decision errors produced by multilevel-determining sampling latches 43, 44 are further reduced. The data receiving device may have single offset canceling control circuit 42. With the data receiving device being incorporated in the semiconductor integrated circuit, therefore, the area taken up by the offset canceling mechanism and the control circuit in the semiconductor integrated circuit may be small, resulting in a reduction in power consumption. Inasmuch as amplifier 41 comprises a differential amplifier for amplifying duobinary data dat and differentially outputting output signal “p”, the signals in the various portions suffer reduced noise and distortions, further reducing decision errors caused by multilevel-determining sampling latches 43, 44.

### Exemplary Embodiment 2

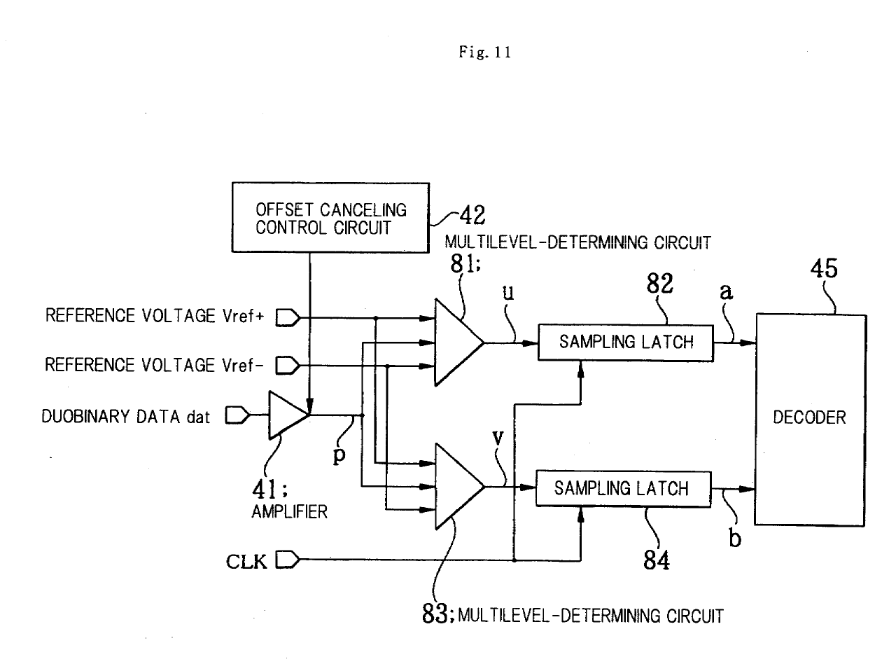

FIG. 11 is a block diagram showing the electric arrangement of a central portion of a data receiving device according to a second exemplary embodiment of the present invention. Those parts of the data receiving device according to the second exemplary embodiment which are identical to those shown in FIG. 7 are denoted by identical reference characters.

As shown in FIG. 11, the data receiving device employs multilevel-determining circuits 81, 83 and sampling latches 82, 84 instead of multilevel-determining sampling latches 43, 44 shown in FIG. 7. Multilevel-determining circuit 81 samples output signal “p” from amplifier 41 based on reference voltage Vref+ to determine the data of output signal “p”, and outputs decision signal “u”. Sampling latch 82 latches decision signal “u” in synchronism with clock signal CLK, and outputs the latched signal as decision signal “a”. Multilevel-determining circuit 83 samples output signal “p” from amplifier 41 based on reference voltage Vref− to determine the data of output signal “p”, and outputs decision signal “v”. Sampling latch 84 latches decision signal “v” in synchronism with clock signal CLK, and outputs the latched signal as decision signal “b”. Other details are identical to those shown in FIG. 7.

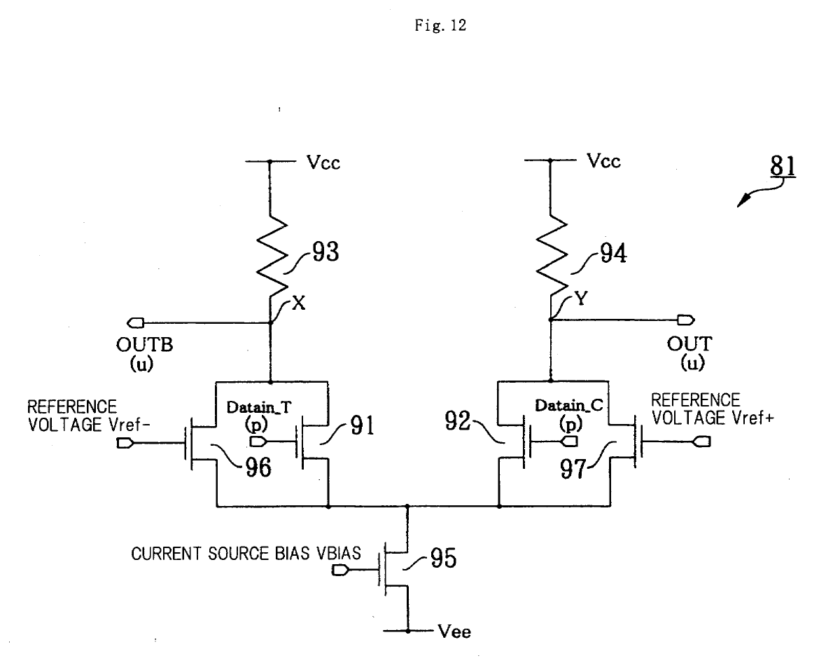

FIG. 12 is a circuit diagram showing the electric arrangement of multilevel-determining circuit 81 shown in FIG. 11.

As shown in FIG. 12, multilevel-determining circuit 81 includes nMOSs 91, 92, resistors 93, 94, and nMOSs 95, 96, 97. Multilevel-determining circuit 83 is the same structure as multilevel-determining circuit 81, except that reference voltage Vref+ is applied to the gate of nMOS 96 and reference voltages Vref− to the gate of nMOS 97.

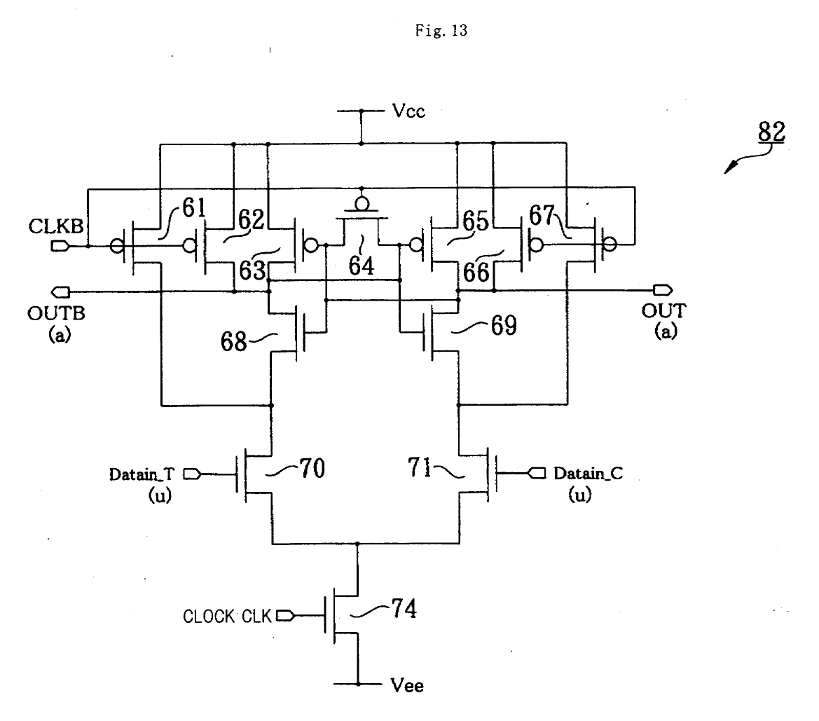

FIG. 13 is a circuit diagram showing the electric arrangement of sampling latch 82 shown in FIG. 11. Those parts of sampling latch 82 which are identical to those shown in FIG. 9 according to the first exemplary embodiment are denoted by identical reference characters.

As shown in FIG. 13, sampling latch 82 is different from multilevel-determining sampling latch 43 in that it is devoid of nMOSs 72, 73 shown in FIG. 9. Other details are identical to those shown in FIG. 9. Sampling clutch 84 is identical to sampling latch 82.

In the data receiving device, when there is a difference between the data pair (differential output signal “p” and reference voltages Vref+, Vref−) from multilevel-determining circuits 81, 83, a difference is developed between the potentials at nodes X, Y. The difference is delivered as decision signals “u”, “v” to sampling latches 82, 84. In sampling latches 82, 84, the latch that is made up of pMOSs 63, 64, 65 and nMOSs 68, 69 increases decision signals “u”, “v” eventually to the state where V(OUT)=H and V(OUTB)=L or V(OUT)=L and V(OUTB)=H, whereupon sampling latches 82, 84 output decision signals “a”, “b”. Decoder 45 decodes decision signals “a”, “b” to recover the data that have been sent.

According to the second exemplary embodiment, as described above, since multilevel-determining circuits 81, 83 and sampling latches 82, 84 are employed instead of multilevel-determining sampling latches 43, 44, the data receiving device offers advantages, as well as the advantages according to the first exemplary embodiment, in that the operating speed of multilevel-determining circuits 81, 83 is increased as all the gains of the input differential pair transistors (nMOSs 91, 92) of multilevel-determining circuits 81, 83 are used to determine the data.

### Exemplary Embodiment 3

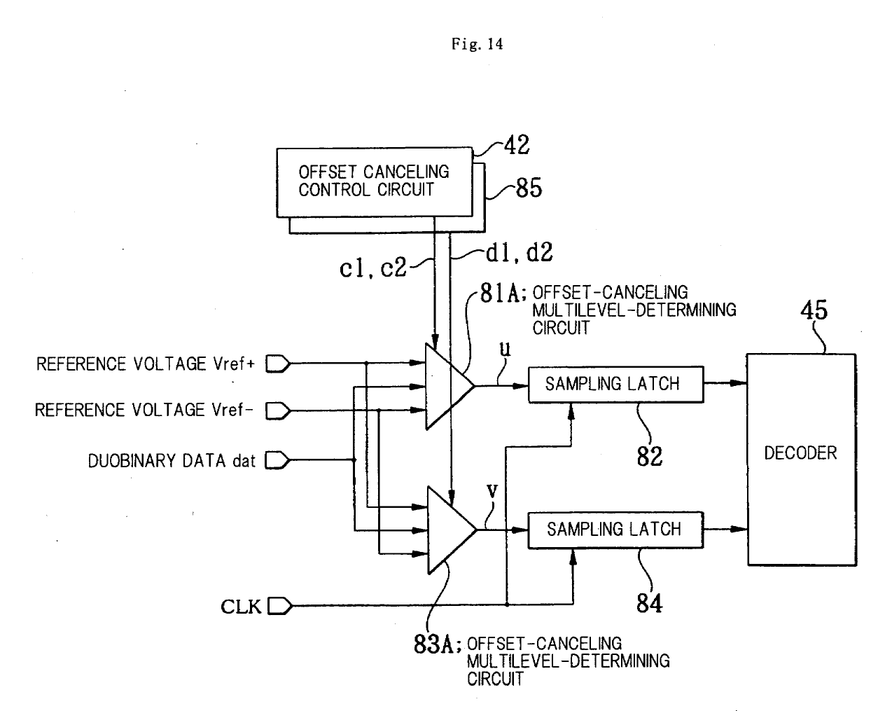

FIG. 14 is a block diagram showing the electric arrangement of a central portion of a data receiving device according to a third exemplary embodiment of the present invention. Those parts of the data receiving device according to the third exemplary embodiment which are identical to those shown in FIG. 11 are denoted by identical reference characters.

As shown in FIG. 14, the data receiving device is devoid of amplifier 41 shown in FIG. 11, employs offset-canceling multilevel-determining circuits 81A, 83A instead of multilevel-determining circuits 81, 83, and includes offset canceling control circuit 84 similar to offset canceling control circuit 42. Offset-canceling multilevel-determining circuits 81A, 83A sample duobinary data dat based on reference voltages Vref+, Vref− to determine the value of duobinary data dat, and output decision signals “u”, “v”.

Multilevel-determining circuits 81A, 83A are capable of canceling an offset of decision signals “u”, “v”. Duobinary data dat comprise differential data. Multilevel-determining circuits 81A, 83A each comprise a differential amplifier having two transistors for being supplied with the differential data and amplifying the differential data and differentially outputting the output signal. Based on offset canceling control signals c1, c2, d1, d2 from offset canceling control circuits 42, 85, multilevel-determining circuits 81A, 83A control currents flowing in the output sections of the transistors to cancel the offset of decision signals “u”, “v”. Other details are identical to those shown in FIG. 11.

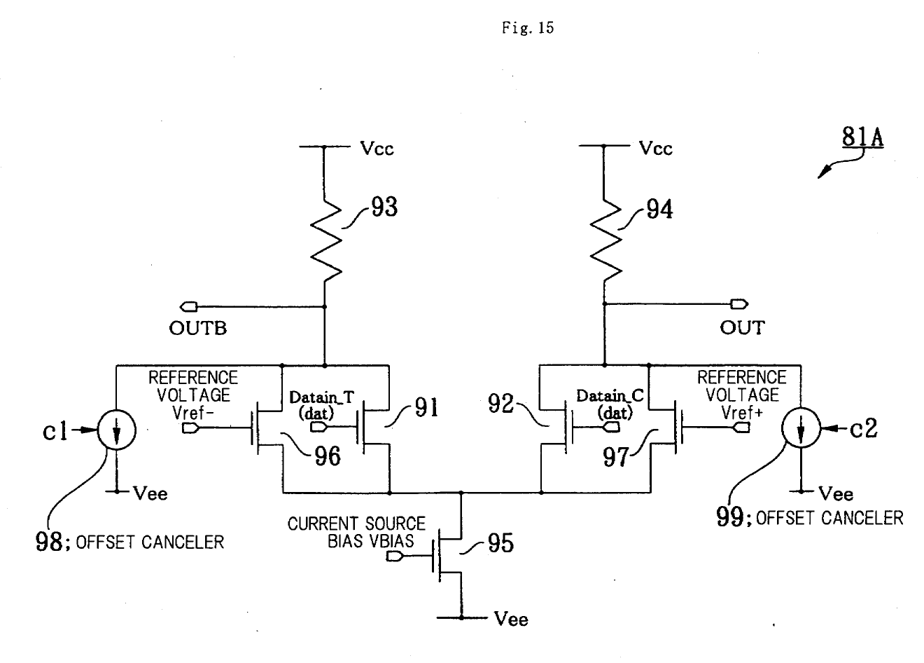

FIG. 15 is a circuit diagram showing the electric arrangement of offset-canceling multilevel-determining circuit 81A shown in FIG. 14. Those parts of offset-canceling multilevel-determining circuit 81A which are identical to those shown in FIG. 12 according to the second embodiment are denoted by identical reference characters.

As shown in FIG. 15, offset-canceling multilevel-determining circuit 81A employs offset cancelers 98, 99, which are identical to offset cancelers 56, 57 shown in FIG. 8, in addition to multilevel-determining circuit 81 shown in FIG. 12. Multilevel-determining circuit 83A is also arranged to cancel an offset of decision signal “v” based on offset canceling control signals d1, d2. Other details are identical to those shown in FIG. 12.

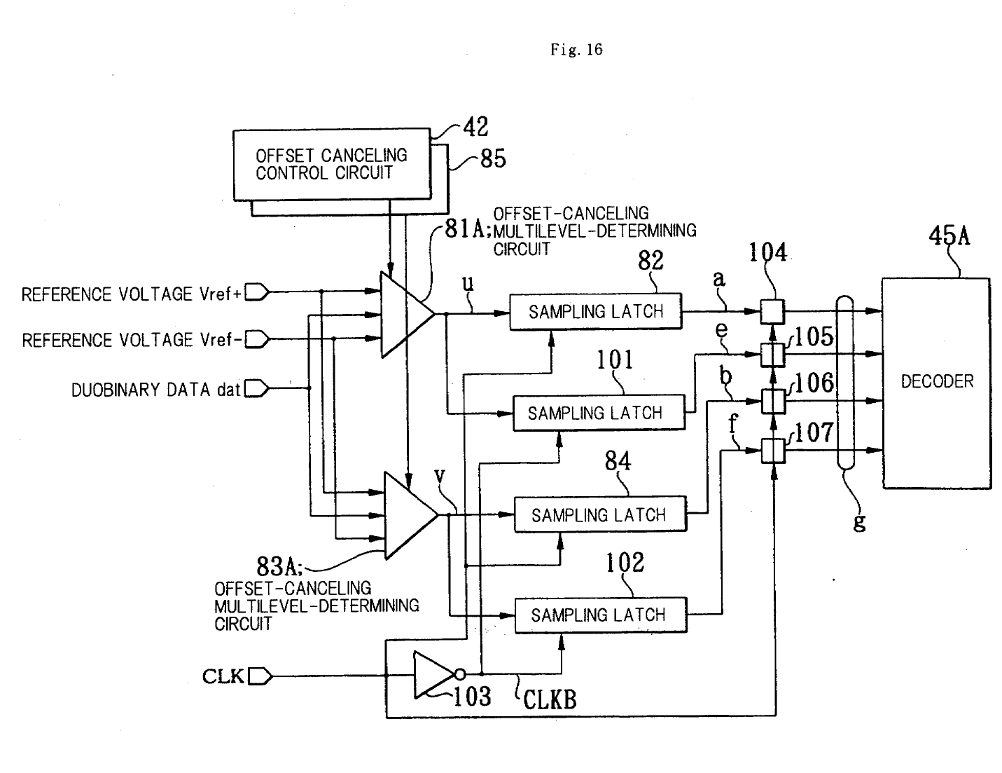

FIG. 16 is a block diagram showing the electric arrangement of a data receiving device which comprises parallelized data receiving devices shown in FIG. 14.

The data receiving device includes, in addition to the data receiving device shown in FIG. 14, sampling latches 101, 102, inverter 103, and flip-flops 104, 105, 106, 107, and employs decoder 45A instead of decoder 45. Inverter 103 inverts clock signal CLK and outputs clock signal CLKB. Sampling latches 101, 102 latch decision signals “u”, “v” from multilevel-determining circuits 81A, 83A in synchronism with clock signal CLKB, and output the latched signals as decision signals “e”, “f”. Flip-flops 104, 105, 106, 107 deliver decision signals “a”, “b”, “e”, “f” in synchronism with clock signal CLK to decoder 45A. Decoder 45A decodes decision signals “a”, “b”, “e”, “f” to recover the data that have been sent.

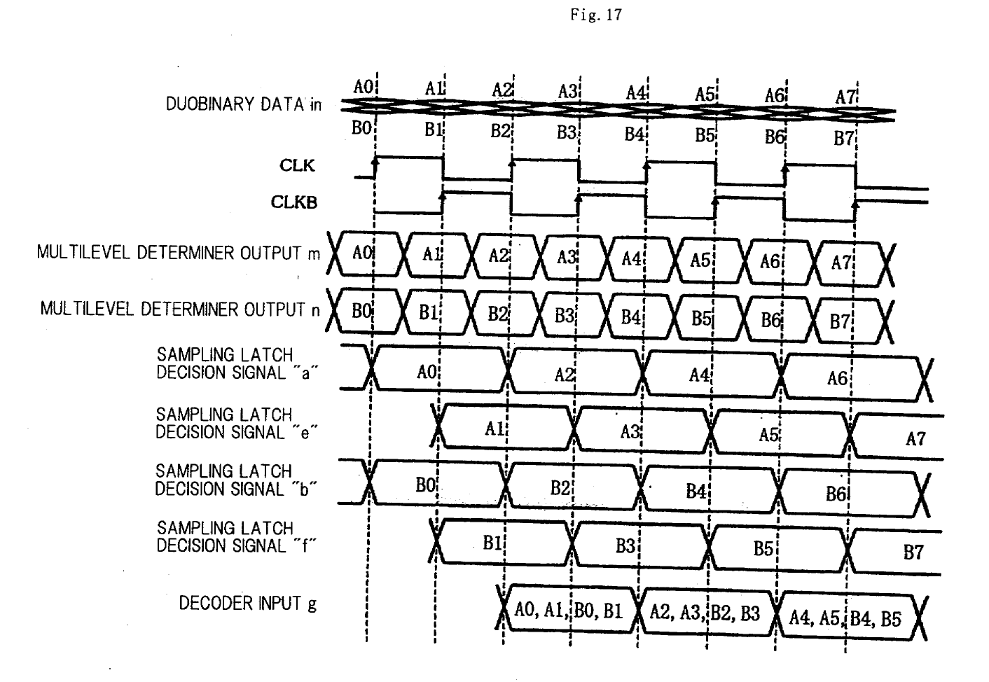

FIG. 17 is a timing chart illustrative of the operation of the data receiving device shown in FIG. 16.

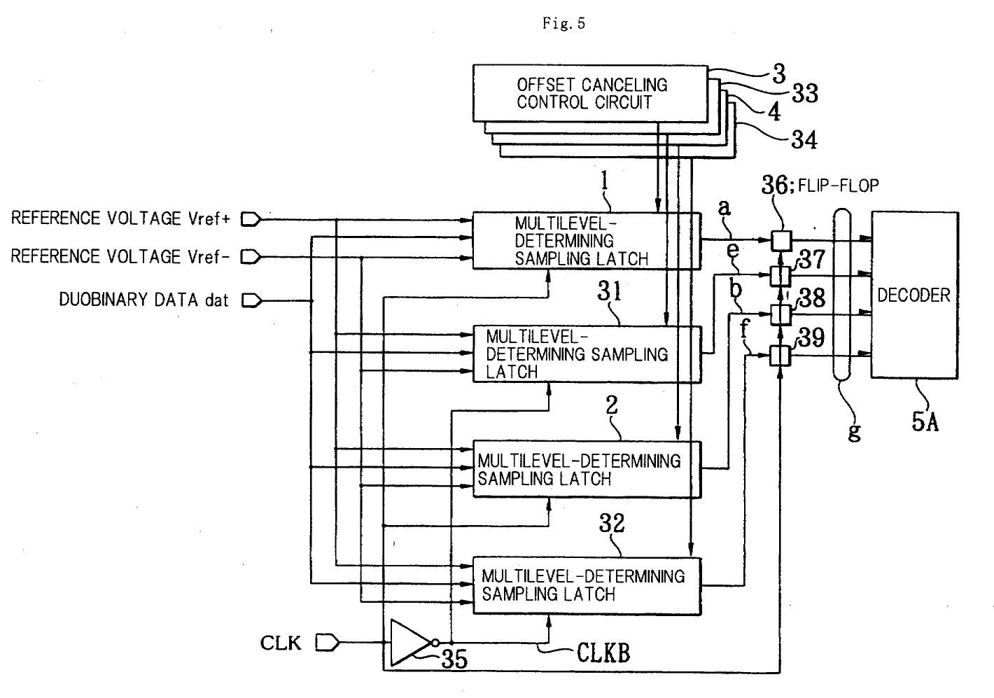

As shown in FIG. 17, the data receiving device has its operating speed reduced to half by using two clock signals CLK, CLKB. Heretofore, as shown in FIG. 5, the parallelized data receiving device requires four multilevel-determining sampling latches, and, as a result, requires four offset canceling mechanisms and four offset canceling control circuits. According to the present exemplary embodiment, offset canceling mechanisms are incorporated in two multilevel-determining circuits 81A, 83A, so that two offset canceling control circuits 42, 85 provide the same function.

According to the third exemplary embodiment, as described above, amplifier 41 shown in FIG. 11 is deleted, and multilevel-determining circuits 81A, 83A and offset canceling control circuit 85 are provided instead of multilevel-determining circuits 81, 83. Though two offset canceling mechanisms and two control circuits are required, the power consumption is reduced because there is no initial-state amplifier.

Multilevel-determining circuits 81A, 83A comprises differential amplifiers for amplifying differential duobinary data dat and differentially outputting output signals. Consequently, decision errors caused by sampling latches 82, 84, 101, 102 are further reduced.

Although the exemplary embodiments of the present invention have been described in detail with reference to the drawings, specific details are not limited to the exemplary embodiments, but the present invention covers design changes as falling within the scope of the invention.

For example, according to the third exemplary embodiment, sampling latches 82, 84 operate in synchronism with clock signal CLK, and sampling latches 101, 102 operate in synchronism with clock signal CLKB. A plurality of sampling latches operating in synchronism with a plurality of clock signals that are out of phase with each other may be added for parallel operation based on clock signals in four or eight phases. The number of offset canceling mechanisms and the number of control circuits do not depend on the number of sampling latches. The arrangements shown in FIGS. 7 and 11 require a single offset canceling mechanism and a single control circuit, and the arrangements shown in FIGS. 14 and 16 require two offset canceling mechanisms and two control circuits. Accordingly, the high-speed operation based on the parallelized system and the reduction in the number of offset canceling mechanisms and the number of control circuits are simultaneously achieved. In each of the above exemplary embodiments, duobinary data dat, output signal p of amplifier 41, and decision signals “a”, “b” are transmitted as differential data based on the balanced transmission scheme. However, the unbalanced transmission scheme may be used to provide the same operation and advantages as with the above exemplary embodiments.

### INDUSTRIAL APPLICABILITY

The present invention is applicable to the entire range of data receiving devices for receiving data sent by duobinary transmission.

What is claimed is:

1-9. (canceled)

10. A data receiving device that receives duobinary data, comprising:
an amplifying circuit that amplifies received duobinary data with a given gain into an output signal;
an offset canceler that cancels an offset of the output signal from said amplifying circuit; and
a data determiner that samples the output signal from said amplifying circuit based on a first reference voltage and a second reference voltage which is of a lower level than said first reference voltage to determine which one of three levels of the duobinary data the received duobinary data have.

11. The data receiving device according to claim 10, wherein said duobinary data comprise differential data;
said amplifying circuit comprises a differential amplifier including two transistors that are supplied with said differential data, amplifies the differential data, and differentially outputs the output signal; and
said offset canceler controls currents flowing through output sections of said transistors to cancel the offset of said output signal.

12. The data receiving device according to claim 11, wherein said data determiner comprises:
a first multilevel-determining circuit that samples the output signal from said amplifying circuit based on said first reference voltage and said second reference voltage to determine whether said received duobinary data are of a high level or an intermediate level among the three levels of the duobinary data;
a first sampling latch that latches a first decision signal from said first multilevel-determining circuit;
a second multilevel-determining circuit that samples the output signal from said amplifying circuit based on said first reference voltage and said second reference voltage to determine whether said received duobinary data are of a low level or the intermediate level among the three levels of the duobinary data; and
a second sampling latch that latches a second decision signal from said second multilevel-determining circuit.

13. A data receiving device that receives duobinary data, comprising:
a data determiner that samples the duobinary data based on a first reference voltage and a second reference voltage which is of a lower level than said first reference voltage to determine which one of three levels of the duobinary data the received duobinary data have;
said data determiner comprising:
a first multilevel-determining circuit that samples said duobinary data based on said first reference voltage to determine whether the received duobinary data are of a high level or an intermediate level among the three levels of the duobinary data;
a first sampling latch that latches a first decision signal from said first multilevel-determining circuit;
a second multilevel-determining circuit that samples said duobinary data based on said second reference voltage to determine whether the received duobinary data are of a low level or the intermediate level among the three levels of the duobinary data; and
a second sampling latch that latches a second decision signal from said second multilevel-determining circuit.

14. The data receiving device according to claim 13, wherein said first multilevel-determining circuit includes:
a first offset canceler that cancels an offset of said first decision signal of the first multilevel-determining circuit; and
said second multilevel-determining circuit includes:
a second offset canceler that cancels an offset of said second decision signal of the second multilevel-determining circuit.

15. The data receiving device according to claim 13, wherein said duobinary data comprise differential data;
each of said first multilevel-determining circuit and said second multilevel-determining circuit comprises a differential amplifier having two transistors that are supplied with said differential data, amplifies the differential data, and differentially outputs an output signal; and
each of said first offset canceler and said second offset canceler controls currents flowing through output sections of said transistors to cancel an offset of said first decision signal and said second decision signal.

16. The data receiving device according to claim 15, wherein said data determiner comprises:
a first multilevel-determining circuit that samples said duobinary data based on said first reference voltage and said second reference voltage to determine whether the received duobinary data are of a high level or an intermediate level among the three levels of the duobinary data;
a first sampling latch that latches a first decision signal from said first multilevel-determining circuit;
a second multilevel-determining circuit that samples said duobinary data based on said first reference voltage and said second reference voltage to determine whether the received duobinary data are of a low level or the intermediate level among the three levels of the duobinary data; and
a second sampling latch that latches a second decision signal from said second multilevel-determining circuit.

17. The data receiving device according to claim 13, wherein said first sampling clutch comprises:
a plurality of latch circuits that latch said first decision signal in synchronism with a plurality of clock signals which are out of phase with each other; and
said second sampling clutch comprises:
a plurality of latch circuits that latch said first decision signal in synchronism with said plurality of clock signals.

18. A semiconductor integrated circuit including a data receiving device according to claim 10.

19. A data receiving device for receiving duobinary data, comprising:
amplifying means for amplifying received duobinary data with a given gain into an output signal;
offset canceling means for canceling an offset of the output signal from said amplifying means; and
data determining means that samples the output signal from said amplifying means based on a first reference voltage and a second reference voltage which is of a lower level than said first reference voltage to determine which one of three levels of the duobinary data the received duobinary data have.

20. A data receiving device for receiving duobinary data, comprising:
data determining means for sampling the duobinary data based on a first reference voltage and a second reference voltage which is of a lower level than said first reference voltage to determine which one of three levels of the duobinary data the received duobinary data have;
said data determining means comprising:
first multilevel-determining means for sampling said duobinary data based on said first reference voltage to determine whether the received duobinary data are of a high level or an intermediate level among the three levels of the duobinary data;
first sampling latch means for latching a first decision signal from said first multilevel-determining means;
second multilevel-determining means for sampling said duobinary data based on said second reference voltage to determine whether the received duobinary data are of a low level or the intermediate level among the three levels of the duobinary data; and
second sampling latch means for latching a second decision signal from said second multilevel-determining means.
